(19) United States
(12) Patent Application Publication
(10) Pub. No.: US 2020/0291699 A1
(43) Pub. Date: Sep. 17, 2020

(54) Door Security Kit And Method for Preventing Hostile Opening Of A Door

(71) Applicant: Jeffrey Wayne Tallent, Morrow, GA (US)

(72) Inventor: Jeffrey Wayne Tallent, Morrow, GA (US)

(21) Appl. No.: 16/355,077

(22) Filed: Mar. 15, 2019

(51) Int. Cl. E05C 19/18; E05B 15/02

(52) U.S. Cl. CPC E05C 19/184; E05Y 2900/132; E05B 15/0205

(57) ABSTRACT

Disclosed is a Door Security Kit comprising (1) a door guard assembly and (2) a modified strike plate, constructed with a top notch and bottom notch. The door guard assembly manifests a cuboid-shaped compartment comprising a rear vertical panel, having an adjustable channel. A mortise cylinder mounted internally to the compartment consists of a modified cam and lever arm on one end and a keyway on, the opposite. The mortise cylinder, connected to a locking/un-locking mechanism, when rotated by a key, operates a mechanism which controls the size of the adjustable channel. The protected door, and the strike plate, are both housed and operate within a commercial door frame. Turning of the mortise cylinder to the locked configuration causes the mechanism to decrease the length of the channel, thereby causing the channel to clamp onto the notches of the strike plate, preventing movement of the, door within the doorframe.

### CROSS-REFERENCES TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT

Not applicable.

### BACKGROUND OF THE INVENTION

### (1) Field of the Invention

The field of the present inventive concept relates generally to methods and equipment utilized to provide an ultra-strong door protective device that can be readily locked by a threatened user from inside the room to be secured. The April 2007 shooting at Virginia Tech has been one of the numerous violent incidents, of a deranged shooter breaching a door within a school, business, or other facility and committing deadly mayhem upon the occupants of one or more rooms.

In particular, classroom doors are usually not constructed with a locking device that may be locked from the inside. Therefore students and school staff personnel are not able to quickly buttress the door against opening as a protective measure. As a result, an assailant has no difficulty breaking into the room, whether it be a school room or a commercial office. The present inventive concept discloses a door security device comprising a portable, lockable metal compartment which engages a corresponding metal, notched strike plate, the strike plate being mounted to a metal door frame which is enveloped within the wall.

### (2) Description of the Related Art, Including Information Disclosed Under 37 CFR 1.97 and 1.98.

U.S. Pat. No. 10,072,455; Smith; Sep. 11, 2018. A temporary door latch device for a pre-hung door and casing. The door has a door lock cylinder opening and a door latch opening and the casing has a latch bolt opening. The device includes a female portion having a pair of opposed and spaced apart resilient fingers, each of said fingers having a plurality of inwardly extending teeth thereon. The female portion is receivable in the door lock cylinder opening and the door latch opening. The male portion has a pair of opposed and spaced apart fingers, each of the fingers having a plurality of teeth thereon. The male portion is receivable in the latch bolt opening and the door latch opening. The teeth on the female portion engage the teeth on the male portion in one orientation and are disengaged in another orientation.

U.S. Pat. No. 10,151,127; Shell, R.; Dec. 11, 2018. The present invention relates to a keyless portable lock for a door. The portable door lock includes a horizontal bar that lays across the door and/or the door frame and a strap with one or more holes. The user pulls on the strap, closes the door and inserts a rod through the one or more strap holes so that the rod lays across the door and the frame on the opposite side of the door as the horizontal bar. This action will prevent the door from being opened. A transverse bar may extend from the horizontal bar at approximately 90 degree angle so that the portable door lock is generally in the shape of an “L.”

U.S. Pat. No. 10,125,526; Mahoney, et. al.; Nov. 13, 2018. A door security apparatus is disclosed herein. The door security apparatus comprises a sleeve member, a door engagement member and a spacer, and is configured to engage a double-lever arm door closer to allow for the locking, of a door from the inside. The apparatus further comprises a locking mechanism for keeping the apparatus attached to the door closer. The door engagement member is configured to engage the top edge of a door, the sleeve member is configured to slidably engage the double-lever arm door closer, and the spacer is configured to connect the door engagement member and the sleeve member.

U.S. Pat. No. 10,041,273; Dieguez, R.; Aug. 7, 2018. An auxiliary lock for preventing a hinged door from opening all the way is provided. The lock comprises a strike plate, a flip lock plate, a catching member to receive a door knob or handle, and a means for connecting the catching member and flip lock plate. In an embodiment, the strike plate may be configured to replace any standard strike plate disposed on an inside portion of a door jamb, and the flap lock plate may longitudinally extend from a hinged connection with strike plate in the direction of an opening door so as to optionally block the door from opening and avoid obstructing a swinging door when disengaged. In use, the catching member may be placed around the door knob or handle so that the means for connecting the catching member and flip lock plate form an inseparable link between the door jamb and door itself.

U.S. Pat. No. 9,127,489; Orlov, et. al.; Sep. 8, 2015. A door stop includes a body having a longitudinal axis and a rotating toggle operably connected to the body. The toggle is rotatable such that a longitudinal axis of the toggle aligns with the longitudinal axis of the body in an insertion position and the longitudinal axis of the toggle is transverse to the longitudinal axis of the body in a locked position. The door stop includes a lock assembly operably mounted to the body to lock the toggle. Monitoring circuitry provides indication of a location of the door stop and/or an alarm mode.

### BRIEF SUMMARY OF THE INVENTION

The disclosed security device, referred to as a Door Security Kit 1, comprises a modified strike plate 70 and a door guard assembly 2. The Door Security Kit I is utilized to prevent a door enclosed in a metal doorframe from being forceably opened under circumstances which threaten the safety of the occupants of a room. The Door Security Kit 1 essentially comprises two components: a modified strike plate 70, and a portable, removable door guard assembly 2.

The door guard assembly 2 comprises a cuboid-shaped compartment 10 which further manifests a vertically-oriented channel 27 and an internally-mounted mortise cylinder 51. The mortise cylinder 51 is mechanically connected to a straight cam 52, which cam 52, during the course of manually activated rotation, makes forceful contact with, and activates, a locking and un-locking mechanism. A standard control key 57 is used to operate the mortise cylinder 51, which is permanently attached within the compartment 10. The door 60 which is to be secured, in the preferred embodiment, is housed, and operates within, a commercial metal door frame 68.

The aforementioned mortise cylinder 51, when turned by the control key 57, activates a mechanism to modify the internal dimension of an adjustably-sized channel 27. The adjustably-sized channel 27 functions, in a locked configuration, by clamping onto the modified strike plate 70, thereby preventing movement of the subject door within the doorframe. The modified strike plate 70 conforms to ASA and ANSI standards, and, in the preferred embodiment, is installed in the door frame 68 within which the protected door 60 is hung.

### BRIEF DESCRIPTION OF THE VIEWS OF DRAWINGS AS EXEMPLARY EMBODIMENTS OF THE INVENTIVE CONCEPT

FIG. 1 is a view of the Door Security Kit 1 as seen from the perspective of a user having installed the Door Security kit 1, by clamping the door guard assembly 2 onto the vertically-oriented round 76 of a modified strike plate 70.

FIG. 2 is a side view of the cover 11, having been removed from its attachment to the main compartment 10 of the door guard assembly 2. Further displayed is the mortise cylinder 51, cylinder spacers 50, mortise cylinder nut 53, modified straight cam 52, lever arm 54, and the control key 57.

FIG. 2A illustrates a typical machine screw 14 used in assembling components of the door guard assembly 2.

FIG. 2B displays a downward-looking view of the door guard assembly 2 as it is secured into position against the interior surfaces of a door jamb 62 and a door 60.

FIG. 3 illustrates the inner surface 16 of the cover 11, the cover 11 having been detached from the compartment 10 of the door guard assembly 2. Further shown is a raised platform 59, which has been permanently attached onto the inner surface 16 of the cover 11. A mortise cylinder 51 is shown, attached to a lever arm 54, in the unlocked configuration.

FIG. 4 again illustrates the inner surface 16 of the cover 11, with the cover 11 having been detached from the compartment 10 of the door guard assembly 2. In FIG. 4, the lever arm 54 is shown oriented upward, corresponding to the locked configuration of the door guard assembly 2.

FIG. 5 is a rendering of the interior of the compartment 10 (after removal of the cover 11 from the door guard assembly 2) in the locked configuration. Further shown in FIG. 5 is the U-bracket 41, adjustable channel 27, the lock-arm 44, ledge 42, fork 43, and mainspring 32.

FIG. 6 depicts the interior of the compartment 10 (after removal of the cover 11 from the door guard assembly 2) in the unlocked configuration. Further shown in FIG. 6 is the strike plate 40, adjustable channel 27, the lock-arm 44, ledge 42, fork 43, and mainspring 32.

FIG. 7 presents a view of the rear face 23(a) of the vertical panel 23, with the Door Security 1 in its fully-assembled condition. Other features shown include an open, adjustably-sized channel 27, an upper flange 18, and a lower flange 19, the lower flange 19 being integral to a locking plate 40.

FIG. 8 presents a side view of the compartment 10 in accordance with section line 8-8 of FIG. 7, after removal of the cover 11. Further shown are the U-bracket 41, fork 43, ledge 42, lock-arm 44, post 38, and the mainspring 32.

FIG. 9 depicts a downward-looking view, or plan view of FIG. 8. Shown are the fastening tabs 30, U-bracket 41, fork 43, ledge 42, lock-arm 44, post 38, and the adjustably-sized channel 27.

FIG. 10 is the profile view of the modified strike plate 70 as seen looking vertically downward, and further illustrating the modified strike plate 70 being attached to a door jamb 62.

FIG 11 depicts a view of the modified strike plate 70, including the bolt-hole 75, a top notch 71 having two shoulders 73 and a cut-out depth, and a bottom notch 72, having two shoulders 73 and a cut-out depth.

### DETAILED DESCRIPTION OF THE INVENTION

The objects, features, and advantages of the inventive concept presented in this application are more readily understood when referring to the accompanying drawings. The drawings, totaling thirteen figures, show the basic components and functions of embodiments and/or methods of use. In the several figures, like reference numbers are used in each figure to correspond to the same component as may be depicted in other figures.

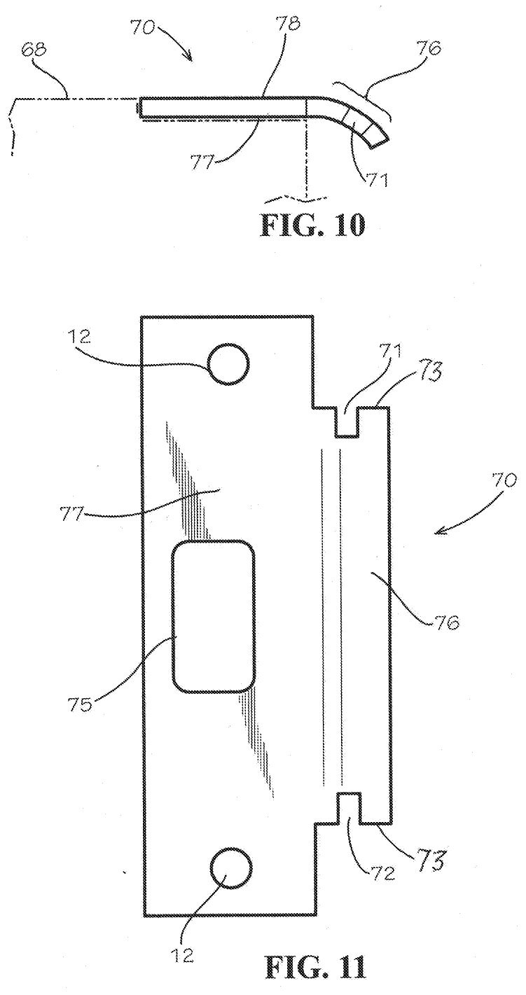

A general description of the Door Security Kit 1 begins with the modified strike plate 70, which features a linear, vertically-oriented curved segment, or round 76. The round 76 is constructed with a longer-than-standard lateral dimension, and also features a top notch 71 and a bottom notch 72, as shown in FIG. 10 and FIG. 11 herein. When the strike plate 70 is mounted within a metal door frame 68, the round 76 protrudes into the protected room, and thereby exposes the top notch 71 and bottom notch 72. In operation of the Door Security Kit 1, a user places the compartment 10 of the door guard assembly 2 in abutment to the round 76 of the strike plate 70.

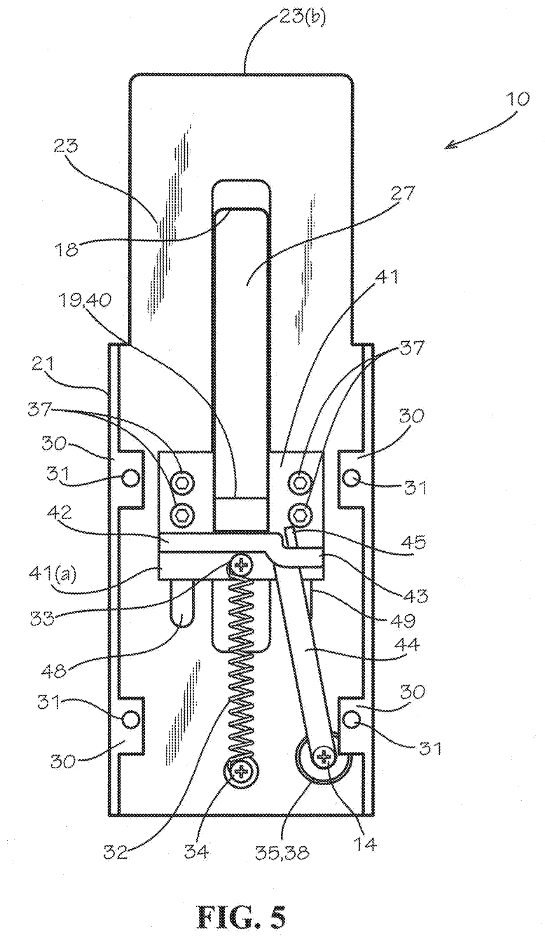

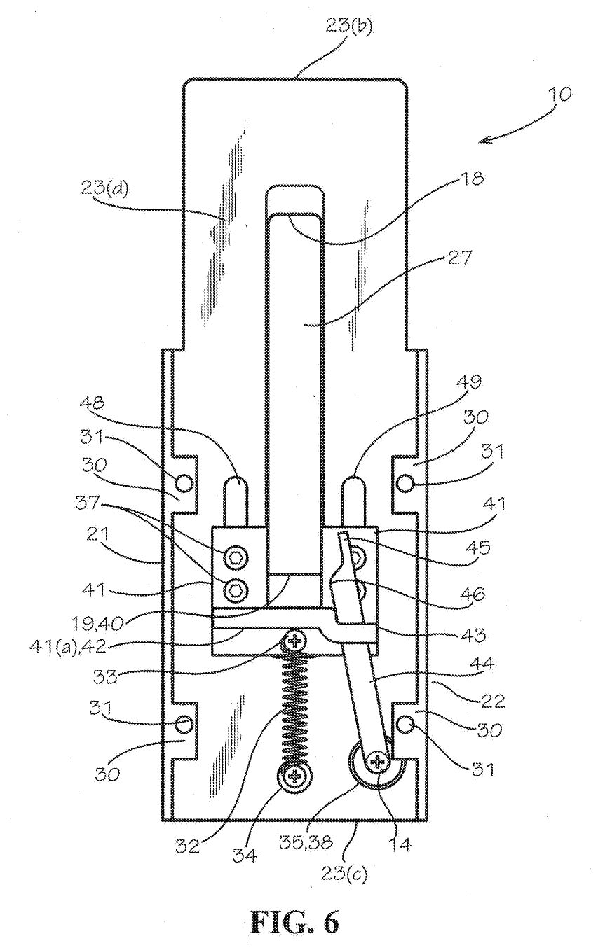

This positioning causes the vertically-oriented, adjustably-sized channel 27 (shown in FIG. 5 and FIG. 6) to be in close proximity to the top notch 71 and bottom notch 72 of the strike plate 70. At this juncture, a user turns the control key 57 clockwise, causing the adjustably-sized channel 27 to diminish in length and to clamp onto both notches 71, 72. The compartment 10 then becomes fully flush simultaneously with the door 60 and doorframe 68. The resultant condition is that the Door Guard Kit 1 barricades the door against all attempts to move the door 60 out of the doorframe 68.

As an operational feature to be noted, the control key 57 cannot be removed from the mortise cylinder 57 unless the door guard assembly 2 is in the locked position. A user may place the door guard assembly 2 on the modified ASA strike plate 70 and allow the door guard assembly 2 to rest on the top notch 71 of the modified strike plate 70. By rotating the control key 57 in the opposite, clockwise direction, the modified straight cam 52 on back of the mortise 51 cylinder will engage the ledge 42 of the U-bracket 41, and move it upwards. The upward motion of the ledge 42 causes the adjustably-sized channel 27to diminish in open length and thereby engage both the bottom notch 72 and the top notch 71 of the modified strike plate 70. This engagement locks the door guard assembly 2 to the modified strike plate 70. The locking of the door guard assembly 2 rigidly retains the door 60 within the metal door frame 68, and the control key 57 can be removed. In a different embodiment, a wall-mounted (or door-mounted) stowage rack 69 may be used wherein the door guard assembly 2 may be similarly clamped and locked onto upper and lower notches of the stowage rack 69, and the control key 57 may then be removed.

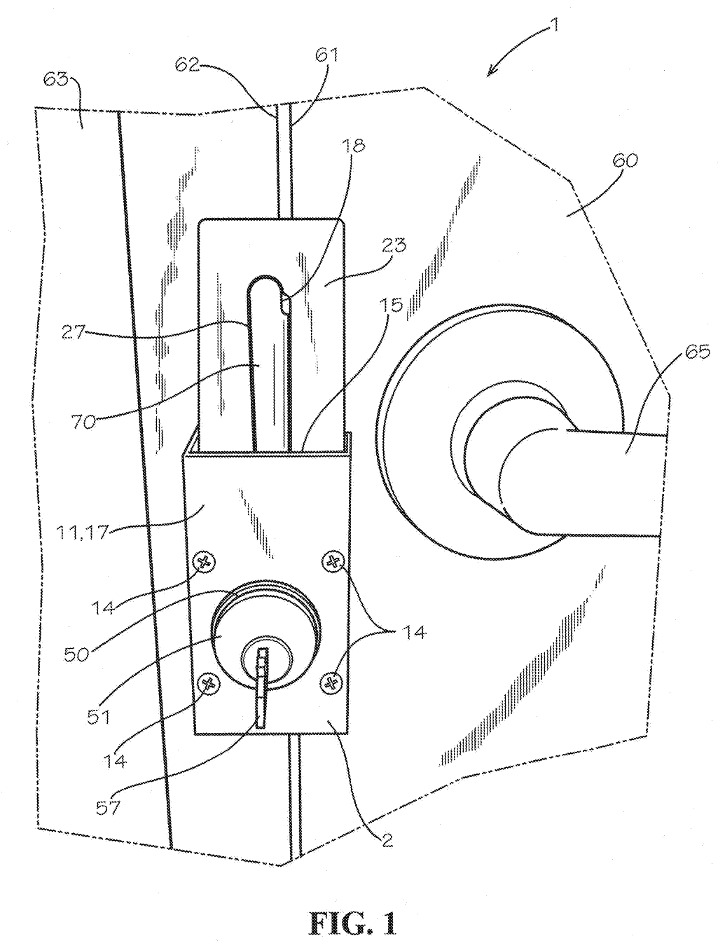

Referring to FIG. 1, there is illustrated a view of the Door Security Kit 1 as seen from the perspective of a user having just enabled the security function of the Door Security Kit 1, by clamping the door guard assembly 2 onto the modified ASA strike plate 70. The control key 57 has been turned to the locked position. The modified strike plate 70 is constructed into the metal door frame 68 of a doorway, with the vertically-oriented round 76 protruding and in view. The exterior 56 of the mortise cylinder 51 is shown as it fits within a circular aperture in the exterior surface 17 of the cover 11 of the door guard assembly 2.

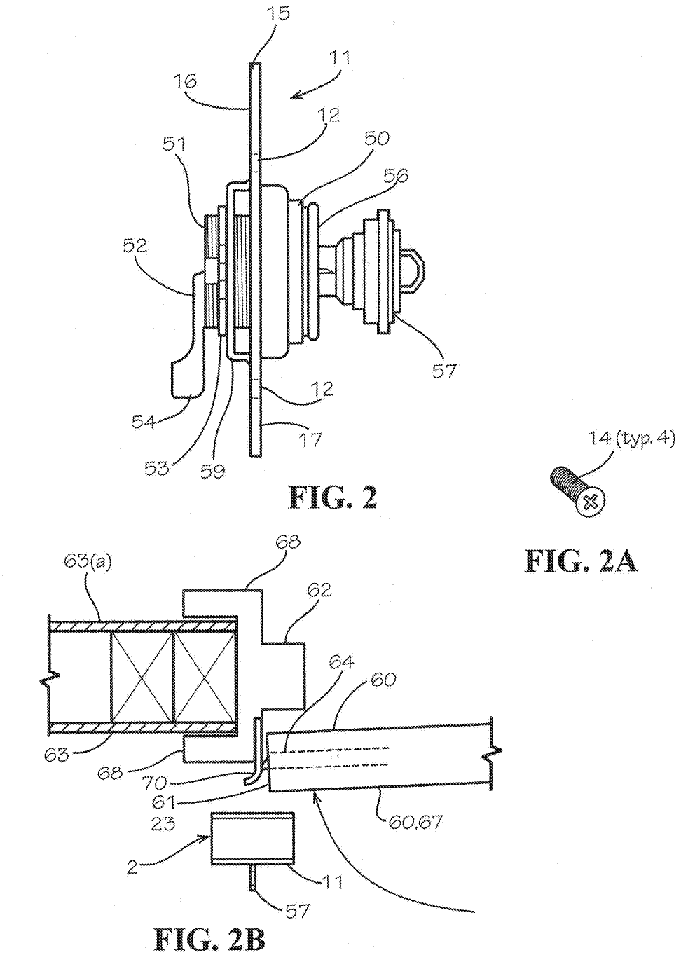

FIG. 2 presents a side view of the cover 11, having been removed from its attachment to the main compartment 10 of the door guard assembly 2. Further displayed are the mortise cylinder 51, cylinder spacers 50, mortise cylinder nut 53, modified straight cam 52, lever arm 54, and the control key 57. FIG. 2(A) illustrates a typical machine screw 14 used in assembling components of the door guard assembly 2 by fastening the cover 11 to the sides of the compartment 10 in some embodiments. In other embodiments, different means of fastening the cover 11 may be used.

The cover top edge 15, counter-sunk holes 12, cover inner surface 16, exterior surface 17, and mortise cylinder exterior 56 are further shown in FIG. 2. The mounting platform 59, a bent, rectangular-shaped structure, contains the outer diameter of the mortise cylinder 51.

In viewing FIG. 2(B), there is shown a stylized, downward-looking view of the door guard assembly 2 is shown imminent to its placement into position for abutment against the interior surfaces 67 of a door 60 and the interior of its associated doorframe 68. The modified strike plate 70 is depicted as constructed into the doorframe 68. A bolt 64, internal to the door 60, is shown in contact with the modified strike plate 70, as the door 60 approaches the closed position.

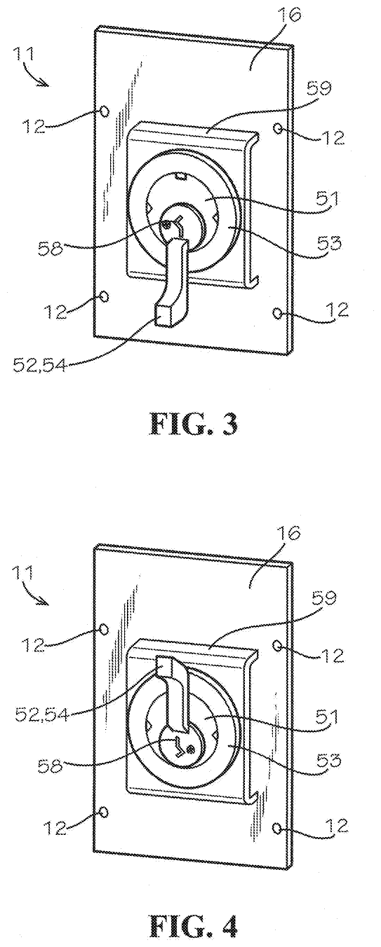

FIG. 3 illustrates the inner surface 16 of the cover 11, with the cover 11 having been detached from the compartment 10 of the door guard assembly 2. Also depicted is the raised platform 59, which has been permanently welded or attached onto the inner surface 16 of the cover 11. A circular hole corresponding to the diameter of the mortise cylinder 51 is constructed through both the cover 11 and the center of the platform 59, which then facilitates the securement of the mortise cylinder 51 within both the platform 59 and the cover 11. The modified straight cam 52 and attached lever arm 54 are further exposed. By counter-clockwise turning of the control key 57 (not shown) in the keyway 58, the straight cam 52 and lever arm 54 are also caused to be rotated, which places the door guard assembly 2, when fully assembled, in an unlocked configuration.

FIG. 4 presents the diametrically opposite configuration of the components integral to the inner surface 16 of the cover 11. Again, the cover 11 is shown having been detached from the compartment 10 of the door guard assembly 2. Shown are the raised platform 59 and the mortise cylinder 51 anchored in place through both the cover 11 and the center of the platform 59. The modified straight cam 52 and attached lever arm 54 are further displayed. However, conversely to FIG. 3, by clockwise rotation of the control key 57 (not shown) in the keyway, 58, the cam 52 and lever arm 54 are shown oriented upward, which places the door guard assembly 2, when fully assembled, in the locked configuration.

Next, in referring to FIG. 5, there is shown an interior view of the compartment 10 of the door guard assembly 2 (with the cover 11 having been removed). This illustrated condition depicts the locked configuration of the compartment 10 of the door guard assembly 2. This configuration results from the mortise cylinder 51 having been rotated clockwise to force the bottom of the ledge 42 upward. The internal functioning of the bracket 41 is the most significant information to be noted from FIG. 5, as the upward movement of the U-bracket 41 results from its direct connection to the ledge 42. The locked configuration shown is reached when, a user rotates the control key 57 in a clockwise direction.

The clockwise rotation of the control key 57 causes the lever arm 54, attached to the straight cam 52 and mortise cylinder 51 (see FIG. 3 and FIG. 4) to both rotate clockwise and, upon reaching a vertical orientation, forcibly engage the bottom surface of the ledge 42. The ledge 42 is integral to, and orthogonally connected to the U-bracket 41.

The U-bracket 41 abuts the front face 23(d) of the vertical panel 23 and is through-connected, by virtue of four plate fasteners 37, the fasteners 37 extending rearward, and connecting to a similarly-dimensioned, planar locking plate 40 (not shown) on the panel rear face 23(a) of the compartment 10.

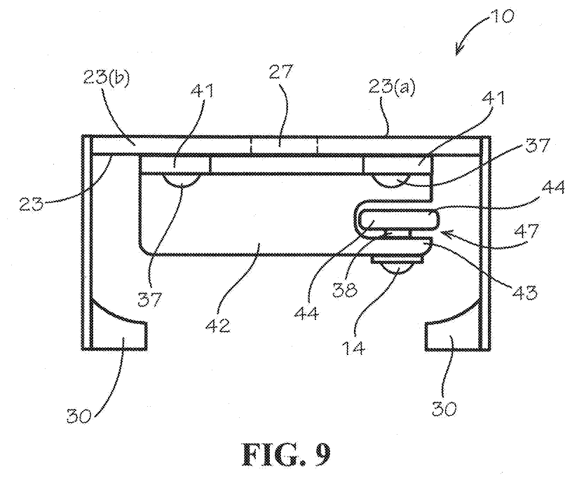

As shown in FIG. 5, the culmination of the upward movement of the ledge 42 eventually provides sufficient clearance for the shoulder 46 (hidden from view) of the lock-arm 44 to slide to the left, and underneath the ledge 42, thereby giving further enforced support and stability to the ledge 42 in the locked position. The entire width of the lock-arm 44 then fits into the gap of the fork opening 47. This condition is also illustrated in FIG. 9. The lever arm 54 is simultaneously placed in a vertical supporting mode directly beneath the ledge 42.

This movement of the ledge 42 into the locked configuration shown in FIG. 5 forces the mainspring 32 to expand and load up with tension. The mainspring 32 remains alignment with its attachment at its upper end to a top fastener 33, and attachment at its lower end to a bottom fastener 34. This is the locked configuration of the Door Security Kit 1 shown in FIG. 4, as well as depicted by the locking position of the lever arm 54, as illustrated in FIG. 9.

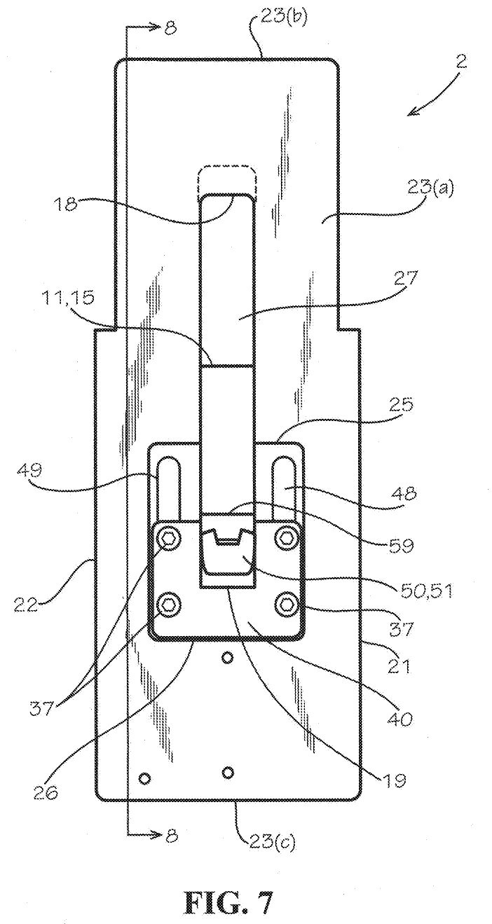

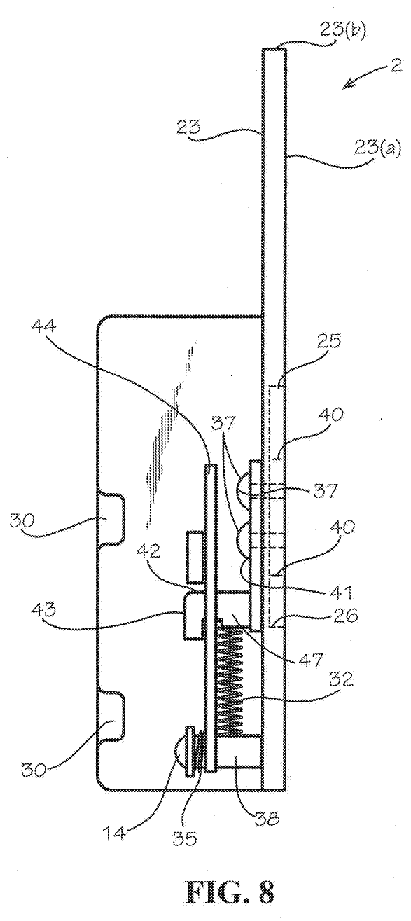

In the locked configuration, the rear-located locking plate 40 (see FIG. 7) has been raised to the upper bay limit 25, this limit being illustrated in FIG. 7 and FIG. 8. As a direct result of the raising of the locking plate 40, there is created a smaller opening of the adjustably-sized channel 27 of the rear panel 23. The smaller opening of the adjustably-sized channel 27 creates a steadfast clamping effect which locks the upper flange 18 of the vertical panel 23 and the lower flange 19 of the U-bracket 41 onto the top notch 71 and the bottom notch 72, respectively, of the corresponding modified strike plate 70.

FIG. 6 illustrates the result of the internal functioning within the compartment 10 of the door guard assembly 2. In this instance counter-clockwise turning of the key 57 causes downward rotation of the modified straight cam 52 (shown in FIG. 3 and FIG. 4), rendering disengagement of the lock-arm 44 from the undersurface of the ledge 42. In this position, the downward movement of the lever arm 54 allows the ledge 42 to move downward, which in turn frees the U-bracket 41 and its lower flange 19 to a lower orientation, releasing the clamping against the bottom notch 72 (not shown) of the modified strike plate 70. Correspondingly, the clamping of the top notch 71 of the strike plate 70 by the upper flange 18 is also relieved, thereby forming the unlocked configuration of the compartment 10 of the door guard assembly, 2.

It is to be noted, in FIG. 6, that the cover 11 has been removed). The positioning of the U-bracket 41 is also notable, as it is illustrated as retained in its unlocked positon by virtue of tension of the mainspring 32 asserting a downward pull on the top fastener 33, which is attached to the lower section 41(a) of the U-bracket 41. The U-bracket 41 is through-connected, by virtue of four plate fasteners 37 which fasteners 37 extend rearward, connecting to a similarly-shaped, planar locking plate 40 (not shown) on the panel rear face 23(a) of the compartment 10.

The unlocked configuration is attained when a user rotates the control key 57 in a counterclockwise direction. The counterclockwise rotation of the control key 57 causes the lever arm 54, attached to the modified straight cam 52 (shown in FIG. 3 and FIG. 4) of the mortise cylinder 51, to also rotate and thereby disengage itself from its abutment with the lower section 41(a) of the ledge 42. Continued counterclockwise rotation of the lever arm 54 also terminates the underlying vertical support supplied to the ledge 42, by the lever arm 54.

Also, relative to the view shown in FIG. 6, the lever arm 54, as it passes through approximately 225 degrees of counter-clockwise rotation, the lever arm 54 comes into contact with, and pushes aside the lock-arm 44. The ledge 42 then loses its under-support, and the mainspring 32 is fully free to pull the ledge 42 and U-bracket 41 downward. Simultaneously, the contoured shoulder 46 of the lock-arm 44 then permits the fork opening 47 to encompass the width and length of the lock-arm 44. This condition is also shown in FIG. 9.

In referring to FIG. 7, there is shown a view of the rear panel 23(a) of the compartment 10, and door guard assembly 2, further showing the locking plate 40. As mentioned previously, the locking plate 40 is connected, by fasteners 37, directly to the U-bracket 41 in the interior of the compartment 10. The locking plate 40 is designed to slidingly travel within a rectangular bay recessed in the rear panel 23(a). Specifically, the recessed bay comprises an upper bay limit 25 and a lower bay limit 26. The locking plate 40, traveling between the two bay limits 25, 26, is maneuvered into either the locked position or the unlocked position of the door guard assembly 2.

In FIG. 7, it is to be noted that the compartment 10 of the door guard assembly 2 has been placed into the unlocked configuration, with the locking plate 40 resting upon the lower bay limit 26. The two pairs of left-side and right-side plate fasteners 37 of the locking plate 40 are constructed such that each pair extends through the width of the locking plate 40 and terminate flush with the surface of the rear panel 23(a). Each of the four plate fasteners 37 has cylindrical axles which axles travel up and down within a left slot 48 and a right slot 49, respectively. This vertical movement of the locking plate 40 from upper bay limit 25 to lower bay limit 26 translates into either a locked configuration or an unlocked configuration of the door guard assembly 2.

Further shown in FIG. 7 is a partial view of the inner drum 51 of the mortise cylinder 50 and the platform 59 within which the inner drum 51 is enclosed. Importantly, it is also noted that the adjustably-sized channel 21 manifests an upper flange 18, which works in conjunction with the lower flange 19. The lower flange 19 is, in actuality, part of the horizontal structure of the locking plate 40.

In reiterating the functions of the door guard assembly, 2 the mainspring 32 when freed, rapidly pulls the U-bracket 41, (permanently connected to the locking plate 40) until the bottom of the locking plate 40 rests against the lower bay limit 26 (see FIG. 7) of the rear panel face 23(a) of the compartment 10. This is the unlocked configuration of the door guard assembly 2, corresponding to the configuration shown as in FIG. 7. As a direct result of the lowering (rendered by a user turning the control key 57 clockwise in the mortise cylinder 51) of the mutually-connected U-bracket 41 and locking plate 40, there is created a lengthened opening in the adjustably-sized channel 27 of the rear panel 23.

The lengthened adjustably-sized channel 27 then presents sufficient space to allow a user to lift the adjustably-sized channel 27 from its forced clamping of the upper notch 71 and lower notch 72 of the modified strike plate 70. The removal is accomplished by the user lifting the compartment 10 upwards, which then allows both the upper flange 18 of the rear panel face 23(a) and the lower flange 19 of the locking plate 40 of the compartment 10 to clear their former connections with the upper notch 71 and lower notch 72, respectively, of the modified strike plate 70.

Upon removal of the compartment 10 of the door guard assembly 2 from the modified strike plate 70, the user may then stow the door guard assembly 2 in a convenient or private location, with the control key 57 remaining immovable from its position within the keyway 58. The door guard assembly 2 when stowed, may be hung onto a specially-constructed, compatible door guard rack 69. By design, the control key 57 cannot be removed from the keyway 58 unless the control key 57 is turned clockwise so as to place the locking plate 40 into the locked configuration. Once that is accomplished, the control key 57 is removable.

The rear face 23(a) of the vertical panel 23, when operationally locked, simultaneously abuts the door jamb 62 and, door interior surface 67 (more clearly shown in FIG 1 and FIG. 2(B). In FIG. 7, other prominent items illustrated include an open channel 27 which terminates at its top end at an upper flange 18, and at its lower end in a lower flange 19, which is integral to a locking plate 40. Additionally visible is a portion of the mortise cylinder 51, partially showing the platform 59 upon which the mortise cylinder 51 is mounted.

As pointed out earlier, the range of travel of the locking plate 40, at its upward limit, causes reduction of the open channel 27 to a minimum vertical length dimension. This minimum length dimension, when coordinated with placement of the adjustably-sized channel 27 upon the strike plate 70 corresponds to attainment of the locked configuration of the Door Security Kit 1.

In the preferred embodiment, four plate fasteners 37, are permanently fastened to the lock plate 40 and in conjunction each having a through-rod 38 which passes through either a left slot 48 or a right slot 49, continuing on to form a permanent bond to the U-bracket 41 (not shown) in the interior of the compartment 10. Minimally visible in FIG. 7 are the left sidewall 21, right sidewall 22, vertical panel bottom 23(c) and vertical panel top 23(b), along with the cover top edge 15.

FIG. 8 presents a side view of the door guard assembly 2 in accordance with section line 8-8 of FIG. 7, after removal of the cover 11. Further shown are the U-bracket 41, fork 43, ledge 42, lock-arm 44, post 38, and, the mainspring 32. Also indicated in FIG. 8 is the upper bay limit 25 and lower bay limit 26, which regulate vertical travel of the locking plate 40. The lock-arm 44 is shown to be retained by the fork 43, and fork opening 47, while the mainspring 32 is in a relaxed state, rendered by the unlocked condition of the door guard assembly 2. Two of the tabs 30 for attachment of the cover 11 are shown. A restraining spring 35 for allowing cushioned movement of the base of the lock-arm 44 is also shown.

FIG. 9 depicts a downward-looking view, or plan view, of FIG. 8. Shown are the fastening tabs 30, U-bracket 41, fork 43, ledge 42, lock-arm 44, fork opening 47, post 38, and the outline of the adjustably-sized channel 27.

FIG. 10 is the profile view of the modified strike plate 70 as seen looking vertically downward, and further illustrating the modified strike plate 70, relative to its attachment to a door jamb 62. FIG. 11 presents a linear view of the modified strike plate 70, including the bolt-hole 75, top notch 71, and bottom notch 72. It is to be noted that the rectangular shape of each the top notch 71 and bottom notch 72 features two shoulders and an inner, cut-out depth.

In summary, under extreme circumstances, where security and protection from the possible breaking of the door lock of a door 60 is necessary for human safety, the Door Security Kit 1 will provide crucial fortification. A user must first access the door guard assembly 2 from its previously stowed location, and ensure that the door guard assembly 2 is in the unlocked configuration. The user next places the adjustably-sized channel 27 of the Door Security 1 directly onto the strike plate 70 in the door jamb 62, then turn the control key 57 clockwise to ensure fortified security of a door.

While preferred embodiments of the present inventive method have been shown and disclosed herein, it will be obvious to those persons skilled in the art that such embodiments are presented by way of example only, and not as a limitation to the scope of the inventive concept. Numerous variations, changes, and substitutions may occur or be suggested to those skilled in the art without departing from the intent, scope, and totality of this inventive concept. Such variations, changes, and substitutions may involve other features which are already known per se and which may be used instead of, in combination with, or in addition to features already disclosed herein. Accordingly, it is intended that this inventive concept be inclusive of such variations, changes, and substitutions, as described by the scope of the claims presented herein.

What is claimed is:

1. A kit for providing securement against the hostile opening of a door to a room in a situation where the occupant or occupants of the room are under threat of imminent harm, the subject door being of the type having an integral deadbolt or spring bolt, hingedly and vertically attached within a doorframe, and closed by means of the deadbolt or spring bolt latching into the doorframe, the kit comprising:
a) a modified ASA/ANSI strike plate having a bolt-hole, two mounting holes, and a faceplate with a lengthwise curvature, said curvature containing a vertically-oriented top notch and a vertically-oriented bottom notch incorporated therein, the strike plate further comprising a width dimension resulting in protrusion of the top notch and bottom notch of the curvature interiorly into a room;
b) a portable, metallic, cuboid-shaped assembly featuring an adjustably-sized open channel, the interior of said channel having an upper flange at one end and a lower flange at the opposite end;
c) a means for adjusting the length of the opening of the adjustably-sized channel between (i) a maximum length corresponding to the dimension between the outermost structure of the top notch and the outermost structure of the bottom notch of the strike plate and (ii) a minimum length corresponding to the dimension between the deepest section of the top notch and the deepest section of the bottom notch; and
d) a means for mechanically locking the adjustably-sized channel, when set at its minimum length, onto a clamping correlation against the deepest section of the top notch and the deepest section of the bottom notch of the modified strike plate, thereby rendering securement against opening of the door.

2. The door security kit of claim 1 wherein the means for adjusting the length and locking of the adjustably-sized channel comprises:
(a) a cuboid-shaped assembly containing an extended, vertical panel housing the variably-sized open channel, the cuboid-shaped assembly further comprising (i) a horizontal ledge integrally attached to a U-bracket; (ii) a mortise cylinder having a keyway and corresponding key on one end and an offset cam connected to a lever arm on the opposite end; (iii) a mounting platform; (iv) a locking plate having a lower flange; (v) a lock-arm; (vi) a mainspring; vii) a plurality of fasteners, each fastener having a linear through-rod; wherein,
(b) the U-bracket fits flush with the front face of the vertical panel and is connected, by four fasteners extending through two vertically-oriented, slots, to the locking plate; (c) the locking plate is confined to moving slidingly within a recessed bay on the rear face of the vertical panel, said bay having an upper bay limit and a lower bay limit; and (d) the lever arm, when rotated clockwise by the mortise cylinder, engages the bottom of the ledge, thereby forcing the U-bracket upwards, consequently pushing the locking plate and lower flange upwards, decreasing the length dimension of the adjustably-sized channel and causing it to enter into a locked configuration.

3. The door security kit of claim 1, wherein a door mounted within a doorframe may be fortified against forced opening by rendering a secure entrapment within the doorframe resulting from placement of the adjustably-sized channel of the cuboid-shaped assembly simultaneously upon the top notch and the bottom notch of the modified strike plate and adjusting the length of the opening of the adjustably-sized channel so as to result in clamping of the adjustably-sized channel about the top notch and bottom notch of the modified strike plate.

4. The door security kit of claim 1, further having a wall- or desk-mountable stowage bracket comprising a plate having a top notch and a bottom notch, the dimensions and location of both notches corresponding to the top notch and bottom notch, respectively, of the modified strike plate, whereupon the door guard assembly may be stowed in readiness.

5. A door security kit for fortification against the threatened, hostile opening of a door, the door being of the type having an integral deadbolt or spring bolt, the door hingedly and vertically attached within a doorframe, and the door closed by means of the deadbolt or spring bolt latching into the doorframe, the kit comprising:
a) a door guard assembly, comprising a cuboid compartment having a left sidewalk, a right sidewall, a bottom, a front cover, and an extended, vertical panel, said panel manifesting a lengthwise, variably-sized open channel, which channel manifests an upper flange, the cuboid compartment further comprising (i) a horizontal ledge integrally attached to a U-bracket; (ii) a mortise cylinder having a keyway and corresponding key on one end and an offset cam connected to a lever arm on the opposite end; (iii) a mounting platform; (iv) a locking plate having a lower flange; (v) a lock-arm; (vi) a mainspring; vii) a plurality of fasteners, each fastener having a linear through-rod; and
(b) a modified strike plate having a bolt-hole, two mounting holes, and a faceplate with, a lengthwise curvature, said curvature containing a vertically-oriented top notch and a vertically-oriented bottom notch incorporated therein, the strike plate further comprising a width dimension such that when the strike plate is mounted into a doorframe, there occurs a protrusion of the top notch and bottom notch interiorly into a room.

6. The door security kit of claim 5, further having a fork with an internal gap, the fork extending outward horizontally the end of the ledge closest to the lock-arm.

7. A method of providing securement against the hostile opening of a door to a room where the occupant or occupants of the room are under threat of imminent harm, the subject door being of the type having an, integral deadbolt or spring bolt, hingedly and vertically attached within a doorframe, and closed by means of the deadbolt or spring bolt latching into the doorframe, the method comprising, the following steps:
a) attaching to the inner doorframe, a modified ASA/ANSI strike plate having, a bolt-hole, two mounting holes, and a faceplate with a lengthwise curvature, said curvature containing a vertically-oriented top notch and a vertically-oriented bottom notch incorporated therein, the strike plate further comprising a width dimension resulting in protrusion of the top notch and bottom notch of the curvature interiorly into a room;
b) providing a portable, metallic, cuboid-shaped structure having an adjustably-sized open channel;
c) providing a means for adjusting the internal length of said channel between a maximum length corresponding to the dimension between the shoulder of the top notch and the shoulder of the bottom notch of the strike plate and (ii) a minimum length corresponding to the dimension between the lowest part of the top notch and the lowest part of the bottom notch;
d) initiating securement of the door against opening by placement of the adjustably-sized channel, in its maximum length configuration, simultaneously over the top notch and bottom notch the channel; and
e) utilizing the means of adjustment to modify the length of the adjustably-sized channel to its minimum length, resulting in a clamping of the entirety of the adjustably-sized channel rigidly against both the top notch and bottom notch of the modified strike plate, thereby providing securement against opening of the door.

8. The method of providing securement as in claim 7, wherein the means for adjusting the length and locking of the adjustably-sized channel comprises:
(a) a cuboid-shaped assembly containing an extended, vertical panel housing the variably-sized open channel, the cuboid-shaped assembly further comprising (i) a horizontal ledge integrally attached to a U-bracket; (ii) a mortise cylinder having a keyway and corresponding key on one end and an offset cam connected to a lever arm on the opposite end; (iii) a mounting platform; (iv) a locking plate having a lower flange; (v) a lock-arm; (vi) a mainspring; vii) a plurality of fasteners, each fastener having a linear through-rod; wherein,
(b) the U-bracket fits flush with the front face of the vertical panel and is connected, by four fasteners extending through two vertically-oriented slots, to the locking plate; (c) the locking plate is confined to moving slidingly within a recessed bay on the rear face of the vertical panel, said hay having an upper hay limit and a lower bay limit; and (d) the lever arm, when rotated clockwise by the mortise cylinder, engages the bottom of the ledge, thereby forcing the U-bracket upwards, consequently pushing the locking plate and lower flange upwards, decreasing the length dimension of the adjustably-sized channel and causing it to enter into a locked configuration.

9. The method of claim 7, further providing a fork with, an internal gap, the fork extending outward horizontally the end of the ledge closest to the lock-arm.

10. The method of claim 7, further providing a wall- or desk-mountable stowage bracket comprising a plate having a top notch and a bottom notch, the dimensions and location of both notches corresponding to the top notch and bottom notch, respectively, of the modified strike plate, whereupon the door guard assembly may be stowed in readiness.

11. A method of preventing the hostile opening of a door to a room when the occupant or occupants of the room are under threat of imminent harm, the subject door being of the type having an integral deadbolt or spring bolt, hingedly and vertically attached within a doorframe and doorframe, and closed by means of the deadbolt or spring, bolt latching into the doorframe, the method comprising the following steps:
a) providing a modified ASA/ANSI strike plate having a bolt-hole, two mounting holes, and a faceplate with a lengthwise curvature, said curvature containing a vertically-oriented top notch and a vertically-oriented bottom notch incorporated therein, the strike plate further comprising a width dimension resulting in protrusion of the top notch and bottom notch of the curvature interiorly into a room;
(b) attaching the modified strike plate to the door jamb such that, upon closing of the door, the deadbolt or spring bolt fits into the bolt-hole and the top and bottom notches are exposed to the interior of the room;
e) providing a cuboid compartment comprising i) a lower box having a left, sidewall, a right sidewall, a cover, and a planar vertical panel having a lengthwise, variably-sized open channel, the channel having an upper flange; (ii) a lock plate having a horizontally-attached ledge and fork; (iii) a rectangular U-bracket with an upper flange; (iv) a lock-arm; and (v) a mainspring;
d) providing a mortise cylinder having, a cam and cam-head constructed, in a rotating manner, onto one end of the mortise cylinder and providing a keyway on the opposite end of the mortise cylinder;
e) constructing a rectangular mounting platform having a circular opening corresponding to the outer circumference of the mortise cylinder;
f) placing the middle section of the mortise cylinder within the circular opening of the platform;
g) permanently mounting the platform onto the interior surface of the cover of the lower box, such that the keyway of the mortise cylinder is oriented on the outer surface of the cover;
h) providing a key corresponding to the keyway of the mortise cylinder;
i) placing the key within the mortise cylinder and turning the key in a counter-clockwise direction so as to provide maximum opening of the variably-sized open channel;
j) placing the upper flange of the channel upon the upper notch, of the strike plate, while simultaneously placing the plate flange above and proximate to, the lower notch of the modified strike plate; and
k) turning the key within the mortise cylinder in a clockwise direction so as to render minimum opening of the variably-sized channel, thereby causing the cuboid compartment to fit flush against the door exterior surface and correspondingly, forcefully close the channel opening about the upper notch, and the lower notch of the modified strike plate.

12. The method disclosed in claim 11, further providing a fork with an internal gap, the fork extending outward horizontally the end of the ledge closest to the lock-arm.

13. The method of claim 11, further providing a wall- or desk-mountable stowage bracket comprising a plate having a top notch and a bottom notch, the dimensions and location of both notches corresponding to the top notch and bottom notch, respectively, of the modified strike plate, whereupon the door guard assembly may be stowed in readiness.
